(19) United States
(12) Patent Application Publication
(10) Pub. No.: US 2024/0102339 A1
(43) Pub. Date: Mar. 28, 2024

(54) REMOVABLE WINDOW FOR EASY CHANGING ROOM LAYOUT

(71) Applicant: A&C FUTURE, INC., Newport Beach, CA (US)

(72) Inventors: Xunmin Jiang, Irvine, CA (US); Jiuqi Wang, Santa Ana, CA (US); Zhuangboyu Zhou, Santa Ana, CA (US); Sichen Li, Santa Ana, CA (US); Ju Gao, Newport Beach, CA (US); Han Qin, Newport Beach, CA (US); Jiayang Qin, Newport Beach, CA (US)

(21) Appl. No.: 17/934,515

(22) Filed: Sep. 22, 2022

(51) Int. Cl. E06B 7/28; E06B 1/36; E06B 3/28

(52) U.S. Cl. CPC E06B 7/28; E06B 1/36; E06B 3/28

(57) ABSTRACT

A removable window includes a frame on the wall that allows the window to be mounted firmly without any gaps between the frame and the window. The frame on the wall can include a rotating locking mechanism that helps secure the removable modules on the wall and prevents the window to be inadvertently knocked down under any unwanted situations. The window can be fitted on the wall by pushing the removable window module into the frame, and the window module can be locked on the wall. When the window module is removed, several different wall modules can be mounted onto the frame. Such wall modules can not only serve as enclosed walls, but can also provide additional functionalities. This effectively allows users to freely move their windows around the house and switch their windows with other walls to change the overall window layout.

### BACKGROUND OF THE INVENTION

### 1. Field of the Invention

Embodiments of the invention relate generally to window construction. More particularly, embodiments of the invention relate to a removable window that can be secured into a frame or can be replaced with a selected type of wall panel.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

When a user is dissatisfied with the window placement of their house or would like to place a piece of furniture where a window is currently positioned, the user is often left with limited options. One option is to simply place the furniture in front of a window. However, such placement may be aesthetically displeasing. Another option is to build a makeshift filler for the window. Such a solution, however, requires time and labor. Further, with such a filler, if the user later wants to go back to having a window, it may be difficult to remove such a filler in a clean and efficient manner. Additionally, such wall fillers often leave the window in place which may result in an unpleasant exterior presentation of the home.

In view of the foregoing, there is a need for methods and devices to solve the above problems to permit users to selectively remove and replace windows with wall panels.

### SUMMARY OF THE INVENTION

Embodiments of the present invention relate to devices and methods that permit a user, instead of rebuilding parts of the house, to easily change the location of a window with little time and labor cost. Such devices and methods can be useful, for example, when a user is dissatisfied with the window placement of their house or when the user would like to place a piece of furniture at where a window is currently positioned.

Embodiments of the present invention provide an interchangeable building opening filling system comprising a frame structure disposed about an interior of an opening; a removable and replaceable panel fitting into the frame structure; and a pivoting locking structure operable to secure the removable and replaceable panel into the frame, preventing inadvertent removal thereof.

Embodiments of the present invention provide a removable window system comprising a frame positioned in an opening in a building construction; a removable and replaceable window panel fitting into the frame; a pivoting locking structure to secure the removable and replaceable window panel into the frame; and a hook member disposed adjacent the pivoting locking structure, wherein the hook member is operable to engage with the pivoting locking structure to retain the pivoting locking structure in a closed position with the removable and replaceable panel fit into the frame structure.

Embodiments of the present invention provide a method for changing a room layout comprising creating a wall with one or more openings each surrounded by a frame; filling the one or more openings with one of a wall panel or a window panel, wherein the wall panel and the window panel are interchangeable; securing the wall panel or the window panel in the opening with a pivoting locking structure; and holding the pivoting locking structure in a closed position, with the window panel or the wall panel disposed into the frame, with a hook member disposed adjacent the pivoting locking structure.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates an inside perspective view of a removable window installed in a wall opening according to an exemplary embodiment of the present invention;

FIG. 1B illustrates an inside front view of the removable window of FIG. 1A;

FIG. 1C illustrates an outside front view of the removable window of FIG. 1A;

FIG. 1D illustrates a top view of the wall having the wall opening of FIG. 1A;

FIG. 2 illustrates an exploded inside perspective view of the removable window of FIG. 1A;

FIG. 3A illustrates an inside perspective view of the removable window in a partially installed configuration;

FIG. 3B illustrates a side view of the removable window in a partially installed configuration of FIG. 3A;

FIG. 4A illustrates an inside perspective view of a removable window in a partially installed configuration illustrating removal thereof;

FIG. 4B illustrates an inside perspective view of a removable window in a partially installed configuration illustrating installation thereof;

FIG. 5A illustrates an inside perspective view of the removable window installed as shown in FIG. 1A;

FIG. 5B illustrates a side view of the removable window of FIG. 5A;

FIG. 5C illustrates a top view of the removable window of FIG. 5A;

FIG. 6A illustrates an inside perspective view of a wall panel fitted in the wall opening and replacing the removable window of FIG. 1A;

FIG. 6B illustrates an outside view of the installed wall panel of FIG. 6A;

FIG. 6C illustrates a top view of a wall with an installed wall panel of FIG. 6A;

FIG. 7A illustrates an inside perspective view of the wall panel installed in FIG. 6A;

FIG. 7B illustrates a side view of the wall panel of FIG. 7A;

FIG. 7C illustrates a top view of the wall panel of FIG. 7A;

FIG. 8A illustrates an inside perspective view of a clothes hanger fitted in the wall opening and replacing the removable window of FIG. 1A;

FIG. 8B illustrates an inside perspective view of the clothes hanger of FIG. 8A;

FIG. 8C illustrates a side view of the clothes hanger of FIG. 8A;

FIG. 8D illustrates a top view of the clothes hanger of FIG. 8A;

FIG. 9A illustrates an inside perspective view of a shelf fitted in the wall opening and replacing the removable window of FIG. 1A;

FIG. 9B illustrates an inside perspective view of the shelf of FIG. 9A;

FIG. 9C illustrates a side view of the shelf of FIG. 9A;

FIG. 9D illustrates a top view of the shelf of FIG. 9A;

FIG. 10A illustrates a perspective view of a rotating mechanism used in the removable window of FIG. 1A;

FIG. 10B illustrates a top view of the rotating mechanism of FIG. 10A;

FIG. 10C illustrates a bottom view of the rotating mechanism of FIG. 10A;

FIG. 10D illustrates a cross-sectional view taken along line XD-XD of FIG. 10B;

FIG. 10E illustrates a cross-sectional view taken along line XE-XE of FIG. 10C;

FIG. 11A illustrates perspective view of a hook member used in the removable window of FIG. 1A;

FIG. 11B illustrates a side view of the hook member of 11B;

FIG. 12A illustrates an inside perspective view of the window opening and installed window frame of FIG. 1A;

FIG. 12B illustrates a front view of the window opening of FIG. 12A;

FIG. 12C illustrates a cross-sectional view taken along line XIIC-XIIC of FIG. 12B; and

FIG. 12D illustrates a cross-sectional view taken along line XIID-XIID of FIG. 12B.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a removable window for standard houses or modular houses. The removable window includes a frame on the wall that allows the window to be mounted firmly without any gaps between the frame and the window. The frame on the wall can include a rotating locking mechanism that helps secure the removable modules on the wall and prevents the window to be inadvertently knocked down under any unwanted situations. The window can be fitted on the wall by pushing the removable window module into the frame, and the window module can be locked on the wall. When the window module is removed, several different wall modules can be mounted onto the frame. Such wall modules can not only serve as enclosed walls, but can also provide additional functionalities. This effectively allows users to freely move their windows around the house and switch their windows with other walls to change the overall window layout.

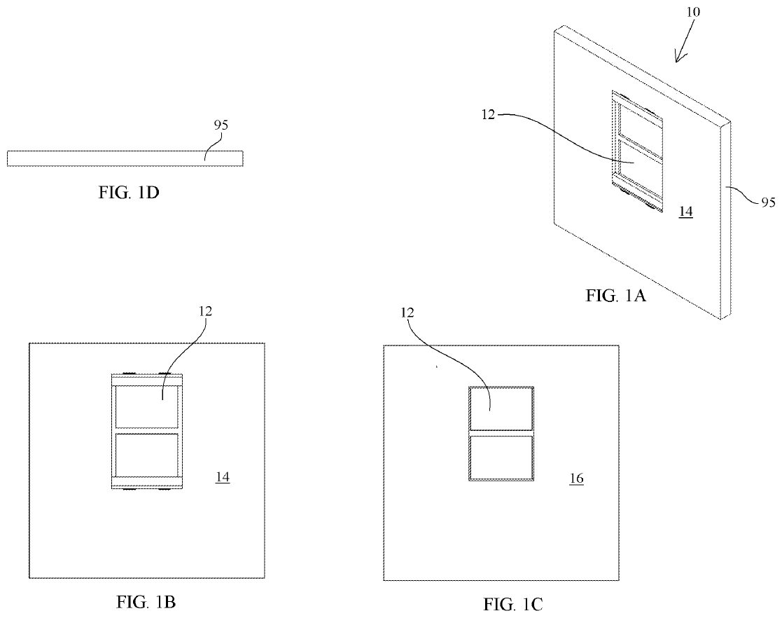

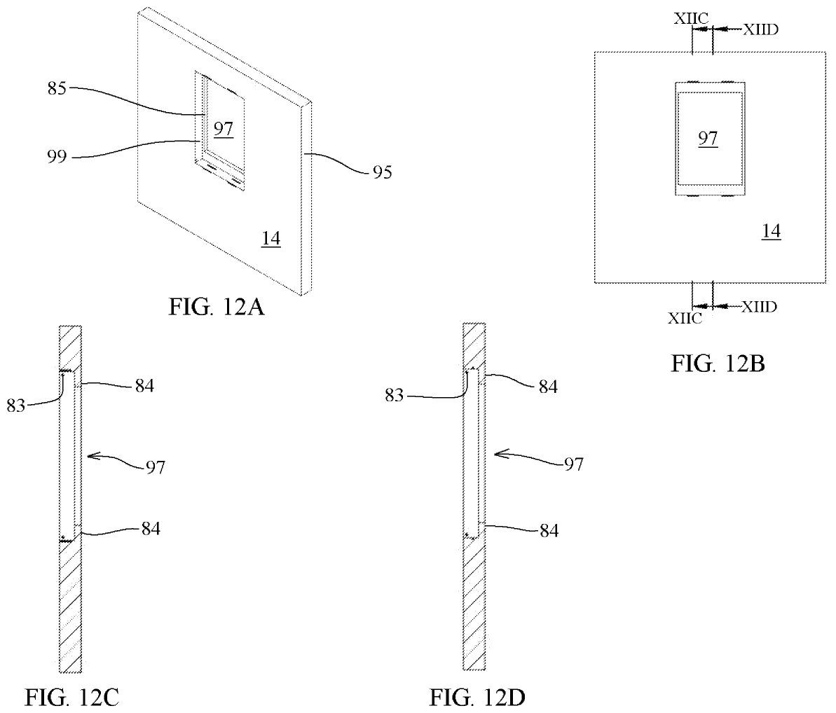

Referring to FIGS. 1A through 1D, a removable window system 10 can include an installed member, such as window 12, installed into an opening 97 of a wall 95 (see FIG. 12A). A specialized frame 99 (see FIG. 12A) can be installed to removable receive the window 12 or other wall members, as discussed in greater detail below. FIGS. 1B and 1C show, respectively, an inside wall 14 view and an outside wall 16 view of the removable window system 10 with the window 12 installed therein. FIG. 1D illustrates how, in some embodiments, the window system 10 does not extend, inward or outward, beyond the framework of the wall 95. The window 12 can be a modified version of any currently existing window, so it can have the functions of any type of window, such as slide to open or rotate to open or the like.

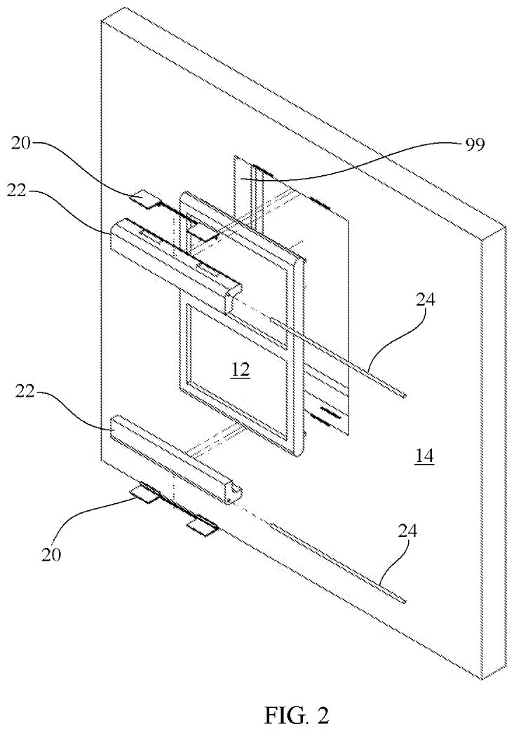

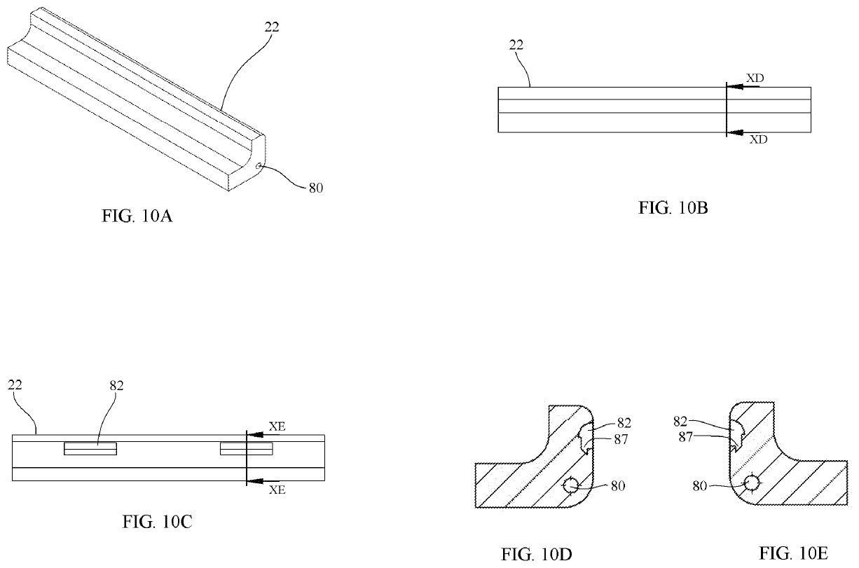

Referring to FIG. 2, a hook member 20 can be disposed at the top and bottom of the frame 99. A rotating member 22 can be pivotable on a shaft 24 that extends through a hole 80 (see FIG. 10A) lengthwise through the rotating member 22. As can be seen in FIG. 2, the structure at the top of the window may be the same as at the bottom of the window.

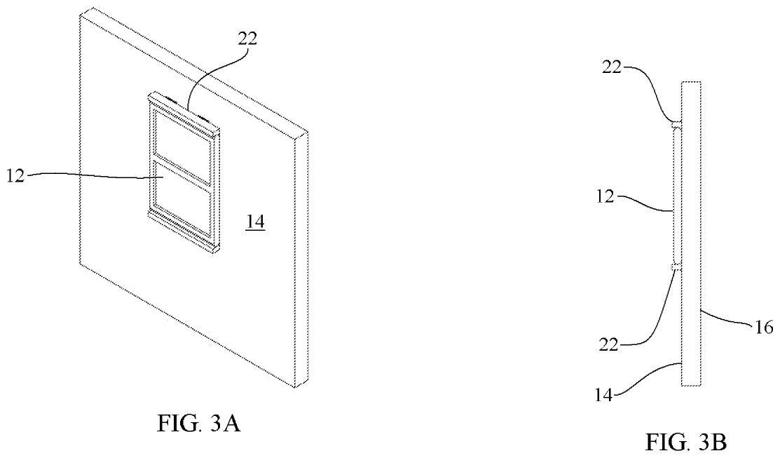

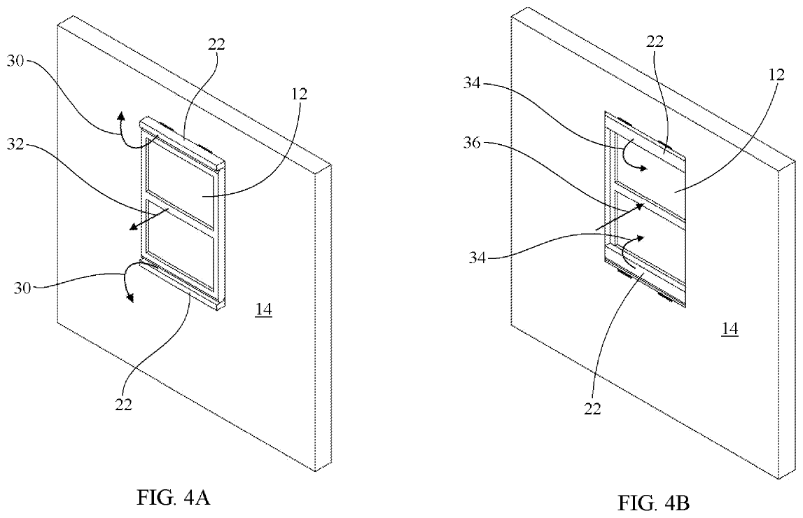

FIGS. 3A through 4B illustrate installation and removal of the window 12 from the frame 99. The rotating members 22 can be rotated to receive the window 12, with one leg of the L-shaped rotating members 22 being disposed along the top of the window 12 and the other leg of the L-shaped rotating members 22 disposed behind the window 12. From this position, as shown by the arrows 30, 32 of FIG. 4A, the window 12 may be removed from the frame 99. Further, from this position, as shown by the arrows 34, 36 of FIG. 4B, the window 12 may be inserted into the frame 12. As discussed in greater detail below, when the rotating members 22 are rotated as shown by arrows 34 in FIG. 4B, the hook member 20 can include a structure that can lock the rotating members 22 into the installed position (as shown in FIG. 4B), thus preventing inadvertent removal of the window 12 from the frame 99.

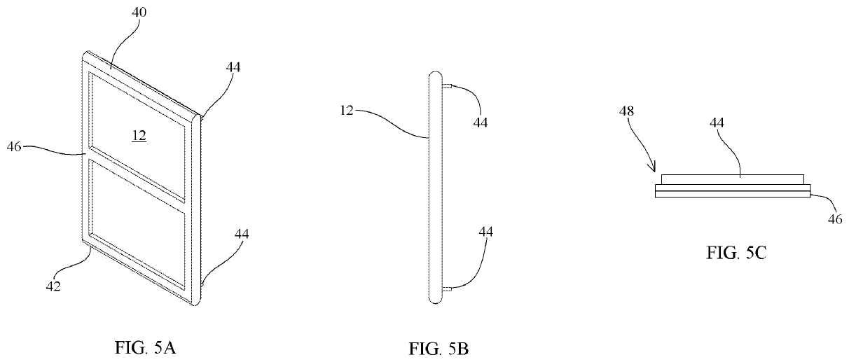

Referring further to FIGS. 5A through 5C, the window 12 is shown. The window 12 can include a frame 46 with a rounded top 40 and a rounded bottom 42. The rounded top 40 and rounded bottom 42 provide a surface upon which the rotating members 22 can rotate. Typically, an inside corner of the L-shaped rotating member 22 can include a rounded inside corner that has the same or a similar radius of curvature as the rounded top 40 and rounded bottom 42.

The frame 46 can define an inside opening size, while an exterior of the window 12 can include two horizontal overhangs 44 that can serve to cover the edge between the window 12 and the frame 99 and to prevent any rainwater from leaking into the frame 99 in the wall. As can be seen, the overhangs 44 extend across the width of the window 12, except for a space 48 disposed between ends of the overhangs 44 and the outer edge of the frame 46. This space 48 may be sized approximate the same size of an outer frame side protrusion 85, as discussed in greater detail below with respect to FIG. 12A. Further, the overhangs 44 may be spaced from the top and bottom of the window 12 by a distance approximately the same as outer frame upper and lower protrusions 84, as discussed in greater detail with respect to FIG. 12C.

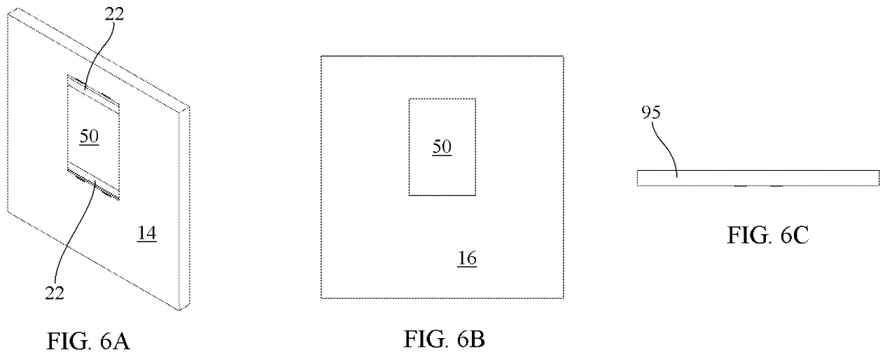

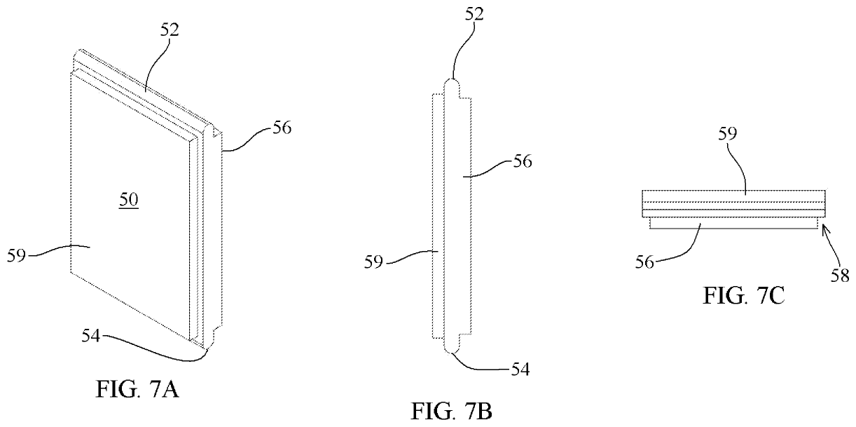

Referring now to FIGS. 6A through 7C, a wall panel 50 can be inserted in place of the window 12, described above. When the window 12 is removed as shown in FIG. 4A, the wall panel 50 can be inserted in its place. The wall panel 50 can typically be flush with an inside wall 14 and/or an outside wall 16. The wall panel 50 can, like the window 12, have a rounded top 52 and a rounded bottom 54. An outer layer 56 of the wall panel 50 may be smaller (by the size of a space 58) than an inside layer 59 so that the outer layer 56 fits within the outer frame side protrusions 85 and the outer frame upper and lower protrusions 84, as described in FIGS. 12A and 12C. Such a configuration can permit the wall panel 50 to be flush with one or both of the inside wall 14 and the outside wall 16.

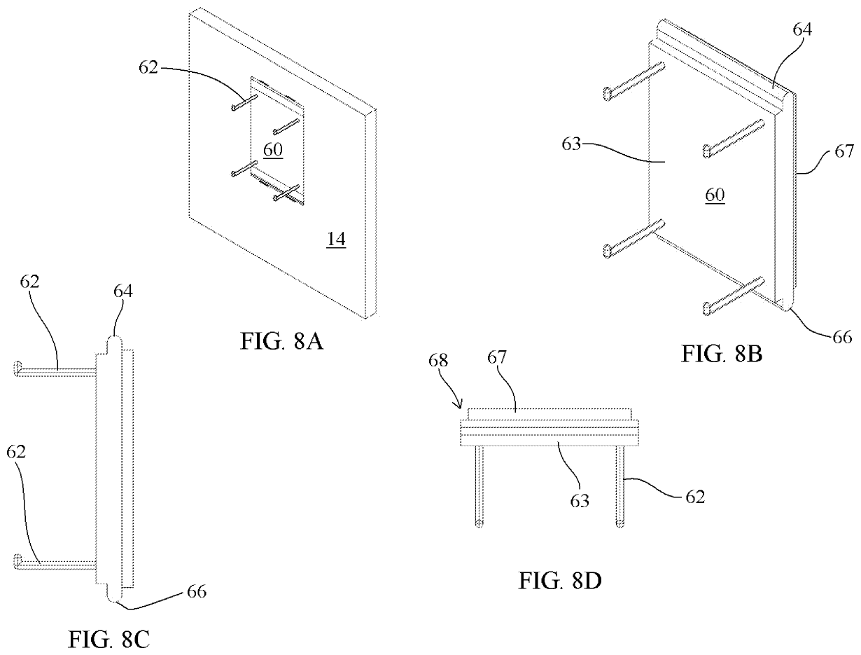

Referring now to FIGS. 8A through 8D, a wall panel can be designed as a clothes hanger wall panel 50 which can be inserted in place of the window 12, described above. When the window 12 is removed as shown in FIG. 4A, the clothes hanger wall panel 60 can be inserted in its place. The clothes hanger wall panel 80 can typically be flush with an inside wall 14 and/or an outside wall 16. The clothes hanger wall panel 60 can, like the window 12, have a rounded top 64 and a rounded bottom 66. A plurality of hanging elements 62 can extend from an inside layer 63 of the clothes hanger wall panel 60. An outer layer 67 of the clothes hanger wall panel 60 may be smaller (by the size of a space 68) than an inside layer 63 so that the outer layer 67 fits within the outer frame side protrusions 85 and the outer frame upper and lower protrusions 84, as described in FIGS. 12A and 12C. Such a configuration can permit the clothes hanger wall panel 60 to be flush with one or both of the inside wall 14 and the outside wall 16.

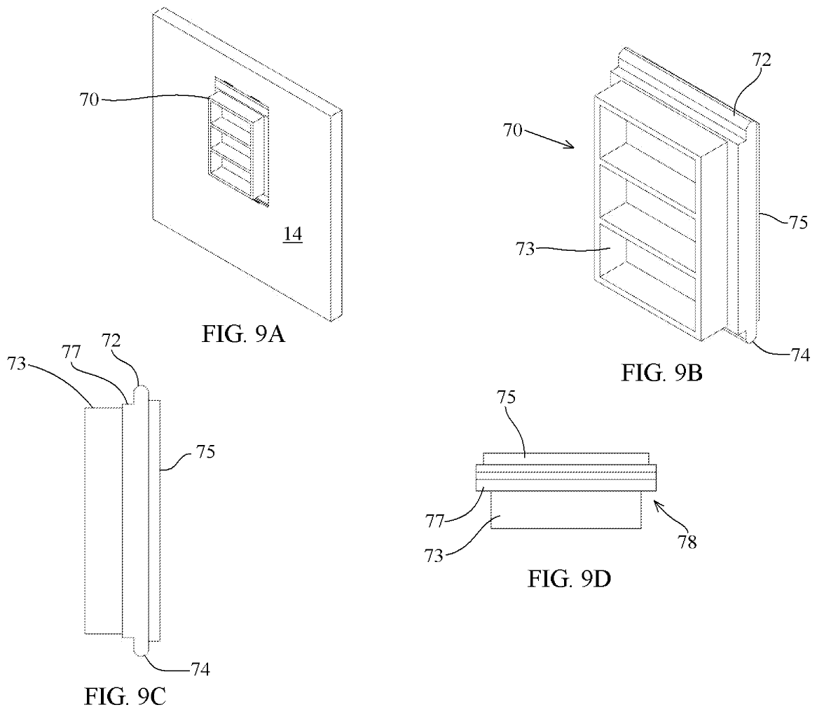

Referring now to FIGS. 9A through 9D, a wall panel can be designed as a bookcase wall panel 70 that can be inserted in place of the window 12, described above. When the window 12 is removed as shown in FIG. 4A, the bookcase wall panel 70 can be inserted in its place. The bookcase wall panel 70 can typically be flush with an inside wall 14 and/or an outside wall 16. The bookcase wall panel 70 can, like the window 12, have a rounded top 72 and a rounded bottom 74. An outer layer 75 of the bookcase wall panel 70 may be smaller (by the size of a space 78) than an inside layer 77 so that the outer layer 75 fits within the outer frame side protrusions 85 and the outer frame upper and lower protrusions 84, as described in FIGS. 12A and 12C. Such a configuration can permit the bookcase wall panel 70 to be flush with one or both of the inside wall 14 and the outside wall 16, typically with the bookcase shelf portion 73 extending into the room from the inside wall 14.

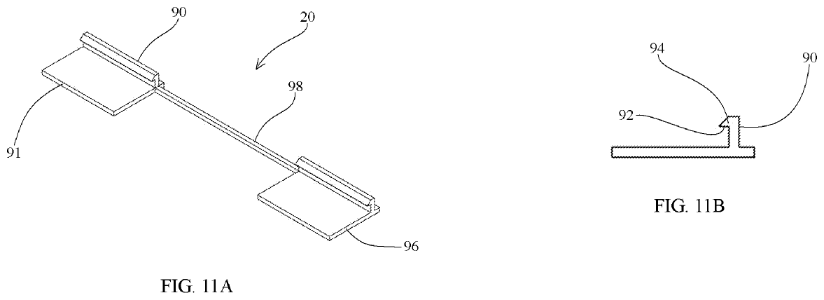

Referring now to FIGS. 10A through 11B, the rotating member 22 can include a hole 80 extending along a lengthwise direction thereof. The shaft 24 (see FIG. 2) can extend through and out both ends of the rotating member 22 to provide a pivot axis for the rotating member 22. The shaft 24 can fit into holes 83 in the frame 99 (see FIG. 12C). The rotating member 22 may be formed in an L-shape, with an inside corner 81 between each of the legs thereof. As discussed above, the curvature of the inside corner 81 may be similar or the same as the curvature of the rounded top and bottoms of the inserts (such as window 12 or wall panel 50, for example).

One or more slots 82 may be formed on an exterior surface of the rotating member 22. The slot 82 may have an interior catch region 87 that can be shaped to catch and hook onto the hook member 20. The hook member can include a flattened portion 96 and a hook portion 90 that extends generally orthogonally from the flattened portion 96. The hook portion 90 can include a hook arm 94 with a hook ledge 92 that can engage with the catch region 87 to secure the hook member 20 to the rotating member 22. Typically, as shown in the Figures, two flattened portions 96 can two hook portions 90 can be interconnected by a connecting shaft 98. Of course, only one set of flattened portions 96/hook portions 90 may be provided or, for longer windows, three of more such sets may be provided along the top and bottom of the window 12 (or the wall panel 50, or the like).

The hook member 22 may be disposed between the outer surface of one leg of the L-shaped rotating member 22 and the frame 99. In some embodiments, the hook member 20 can be resiliently held on position with a front surface 91 of the hook member 20 generally flush with the front of the inside wall 14. A spring (not shown) or other similar resiliently deformable member may permit the hook member to be resiliently slid backward, toward the outside of the opening. When the hook member 22 is pushed by the user and resiliently slid toward the outside, the hook arm 94 and hook ledge 92 can disengage with the catch region 87, allowing the rotating member 22 to pivot to permit removal of the window 12 (or wall panel 50, or the like). By having the hook member 22 resiliently disposed in the forward position (with the front surface 91 generally flush with the front of the inside wall 14), the hook member 22 can engage with the catch region 87 can maintain the engagement until acted upon by the user.

Referring to FIGS. 12A through 12C, the opening 97 in the wall 95 can be used to house the frame 85. As discussed above, the frame 85 can include an inside opening 83 that is larger than the outside opening due to upper and lower protrusions 84 that make the top and bottom of the inside opening 83 smaller, along with side protrusions 85 that make the sides of the inside opening 83 smaller at the outside face of the opening 97.

While the above illustrates the rotating members 22 and the hook members 20 on the top and bottom of the window 12 (or the wall panel 50, or the like), it should be understood that the opening can be designed for these elements to be at the sides of the opening 97. In some embodiments, all four sides of the opening 97 may be configured with rotating members 22 and hook members 20 to secure the window 12 (or the wall panel 50, or the like) into position along all four edges thereof.

While the above illustrates examples for the various types of wall panels, such as a blank wall panel, a clothes hanger wall panel and a bookcase wall panel, it should be understood that the wall modules can integrate additional functionalities so these wall panels can not only serve as a wall but also be a part of the furniture or interior decoration, for example. Accordingly, other objects may be added to, for example, the blank wall panel to add functionality as built-in furniture, such as a seat, table, or the like attached to the wall panel, or to include some interior décor item, such as a picture, work of art, or the like.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. An interchangeable building opening filling system comprising:
a frame structure disposed about an interior of an opening;
a removable and replaceable panel fitting into the frame structure; and
a pivoting locking structure operable to secure the removable and replaceable panel into the frame, preventing inadvertent removal thereof.

2. The interchangeable building opening filling system of claim 1, wherein the removable and replaceable panel is at least one of a window panel or a wall panel.

3. The interchangeable building opening filling system of claim 2, wherein the wall panel is selected from the group consisting of a flat wall panel, a clothes hanger, a bookcase, one or more interior decoration items, and one or more built-in furniture items.

4. The interchangeable building opening filling system of claim 1, further comprising a hook member disposed adjacent the pivoting locking structure, wherein the hook member is operable to engage with the pivoting locking structure to retain the pivoting locking structure in a closed position with the removable and replaceable panel fit into the frame structure.

5. The interchangeable building opening filling system of claim 4, wherein the hook member is configured to be moved, by a user on an inside of the opening, to disengage the pivoting locking structure, thus permitting the pivoting locking structure to pivot and permit removal of the removable and replaceable panel.

6. The interchangeable building opening filling system of claim 4, wherein the hook member includes a hook arm operable to hook into a slot formed in one portion of the pivoting locking structure when in the closed position.

7. The interchangeable building opening filling system of claim 6, wherein the hook arm includes at least two distinct hook arms fitting into respective at least two slots formed along the pivoting locking structure.

8. The interchangeable building opening filling system of claim 1, wherein the pivoting locking structure is an L-shaped member having an inside corner movable along a surface of the removable and replaceable panel.

9. The interchangeable building opening filling system of claim 8, wherein the pivoting locking structure is pivotable on a shaft extending through and beyond longitudinal ends of the pivoting locking structure, wherein ends of the shaft are disposed in holes in opposite sides of the frame structure.

10. The interchangeable building opening filling system of claim 1, wherein a pair of pivoting locking structures are disposed on opposite sides of the frame structure.

11. The interchangeable building opening filling system of claim 10, wherein the pair of pivoting locking structures are disposed at a top and a bottom side of the frame structure.

12. The interchangeable building opening filling system of claim 1, wherein the removable and replaceable panel has an outer layer smaller than an inner layer, wherein at least opposite outer edges of the outer layer are spaced an inward distance from at least opposite respective outer edges of the inner layer.

13. The interchangeable building opening filling system of claim 12, wherein:
the removable and replaceable panel is a wall panel; and
the frame has one or more protrusions extending inward along at least opposite outer edges thereof, the protrusions protruding inward a distance approximating the inward distance.

14. The interchangeable building opening filling system of claim 12, wherein:
the removable and replaceable panel is a window panel;
the window panel having overhangs extending outward from an exterior surface along a top and bottom of the window panel and spaced a distance inward from the top and bottom of the window panel; and
the frame has one or more protrusions extending inward along at least opposite top and bottom outer edges thereof, the protrusions protruding inward a distance approximating the distance inward.

15. A removable window system comprising:
a frame positioned in an opening in a building construction;
a removable and replaceable window panel fitting into the frame;
a pivoting locking structure to secure the removable and replaceable window panel into the frame; and
a hook member disposed adjacent the pivoting locking structure, wherein the hook member is operable to engage with the pivoting locking structure to retain the pivoting locking structure in a closed position with the removable and replaceable panel fit into the frame structure.

16. The removable window system of claim 15, further comprising a wall panel operable to fit into the frame when the removable and replaceable window panel is removed, the wall panel secured in the frame by the pivoting locking structure held into a closed position by the hook member.

17. The removable window system of claim 15, wherein the hook member is configured to be moved, by a user on an inside of the opening, to disengage the pivoting locking structure, thus permitting the pivoting locking structure to pivot and permit removal of the removable and replaceable window panel.

18. A method for changing a room layout, comprising:
creating a wall with one or more openings each surrounded by a frame;
filling the one or more openings with one of a wall panel or a window panel, wherein the wall panel and the window panel are interchangeable;
securing the wall panel or the window panel in the opening with a pivoting locking structure; and
holding the pivoting locking structure in a closed position, with the window panel or the wall panel disposed into the frame, with a hook member disposed adjacent the pivoting locking structure.

19. The method of claim 18, further comprising removing the wall panel or the window panel fit into the opening and replacing with wall panel or the window panel with another, different one of the wall panel or the window panel.

20. The removable window system of claim 15, further comprising moving the hook member, by a user on an inside of the opening, to disengage the pivoting locking structure, thus permitting the pivoting locking structure to pivot and permit removal of the window panel or the wall panel.
